(19) United States
(12) Patent Application Publication
(10) Pub. No.: US 2024/0378280 A1
(43) Pub. Date: Nov. 14, 2024

(54) SYSTEMS AND METHODS FOR CONTINUAL DEVICE AUTHENTICATION IN VIRTUAL ENVIRONMENTS

(71) Applicant: BANK OF AMERICA CORPORATION, Charlotte, NC (US)

(72) Inventors: Stephen Brown, Waxhaw, NC (US); George Anthony Albero, Charlotte, NC (US); Winsome Donaldson, Charlotte, NC (US); Olga Kocharyan, Matthews, NC (US); Elizabeth Rhodes Kral, Fort Mill, SC (US)

(73) Assignee: BANK OF AMERICA CORPORATION, Charlotte, NC (US)

(21) Appl. No.: 18/195,707

(22) Filed: May 10, 2023

(51) Int. Cl. G06F 21/44; G06F 21/32

(52) U.S. Cl. CPC G06F 21/44; G06F 21/32

(57) ABSTRACT

Systems, methods, and computer program products are provided herein for continual device authentication in virtual environments. An example method includes receiving a request for authentication of a first user device associated with a first user where the first user device is associated with a virtual reality environment for the first user. The method further includes receiving authentication credentials associated with the first user and authenticating the first user device for accessing the virtual reality environment based on the authentication credentials. The received authentication credentials may include one or more unique device identifiers associated with the first user device. The method may further include causing presentation of a plurality of virtual input objects in the virtual reality environment and receiving one or more user inputs via the plurality of virtual input objects in the virtual reality environment for determining the authentication credentials associated with the first user.

### TECHNOLOGICAL FIELD

Example embodiments of the present disclosure relate generally to device authentication and, more particularly, to systems and methods for controlling device authentication in virtual environments.

### BACKGROUND

Electronic networks, communication systems, computing devices, and other systems may authenticate or otherwise verify devices and associated users that interact with these systems. The advent of virtual reality environments that are generated, supported, or associated with these systems have provided additional complexity for authenticating device interactions. Applicant has identified a number of deficiencies and problems associated with conventional authentication systems and associated methods. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided herein for continual device authentication in virtual environments. In one aspect, a system for continual device authentication in virtual environments may include at least one non-transitory storage device and at least one processor coupled to the at least one non-transitory storage device. The at least one processor may receive a request for authentication of a first user device associated with a first user where the first user device is associated with a virtual reality environment for the first user. The processor may further receive authentication credentials associated with the first user and authenticate the first user device for accessing the virtual reality environment based on the authentication credentials.

In some embodiments, the processor may be further configured to cause the first device to render the virtual reality environment for the first user.

In some embodiments, the received authentication credentials may further include one or more unique device identifiers associated with the first user device.

In some embodiments, the request for authentication of the first user device may be associated with an existing session of the virtual reality environment for the first user and the associated first user device.

In some further embodiments, the at least one processor may be further configured to cause presentation of a plurality of virtual input objects in the virtual reality environment and receive one or more user inputs via the plurality of virtual input objects in the virtual reality environment. In such an embodiment, the at least one processor may determine the authentication credentials associated with the first user based upon the one or more user inputs.

In some further embodiments, the one or more user inputs received via the plurality of virtual input objects in the virtual reality environment may correspond to one or more unique device identifiers associated with the first user device.

In other further embodiments, the at least one processor may be further configured to randomize the plurality of virtual input objects in the virtual reality environment for subsequent authentication of the first user device during the existing session of the virtual reality environment for the first user and the associated first user device.

In other further embodiments, the at least one processor may be further configured to iteratively authenticate the first user device for accessing the virtual reality environment based on authentication credentials iteratively determined during a time period associated with the existing session of the virtual reality environment.

In some still further embodiments, the first user may be associated with a first avatar that is a digital representation of at least a portion of the first user in the virtual reality environment. In such an embodiment, the at least one processor may be further configured to receive one or more biometric indicators defined by the first avatar of the first user and determine the authentication credentials associated with the first user based upon the one or more biometric indicators of the first avatar.

In other still further embodiments, the at least one processor may be further configured to halt presentation the existing session of the virtual reality environment for the first user and the associated first user device in response to a failure to receive valid authentication credentials associated with the first user.

In another aspect, a computer program product for continual device authentication in virtual environments is provided. The computer program product may include a non-transitory computer-readable medium comprising code. The code, when executed, may cause an apparatus to receive a request for authentication of a first user device associated with a first user where the first user device is associated with a virtual reality environment for the first user, receive authentication credentials associated with the first user, and authenticate the first user device for accessing the virtual reality environment based on the authentication credentials.

In another aspect, a method for continual device authentication in virtual environment is provided. The method may include receiving a request for authentication of a first user device associated with a first user where the first user device is associated with a virtual reality environment for the first user, receiving authentication credentials associated with the first user, and authenticating the first user device for accessing the virtual reality environment based on the authentication credentials.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below. The features, functions, and advantages that are described herein may be achieved independently in various embodiments of the present disclosure or may be combined with yet other embodiments.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for continual device authentication in virtual environments in accordance with one or more embodiments of the present disclosure;

FIG. 2 illustrates a method for continual device authentication in virtual environments in accordance with one or more embodiments of the present disclosure;

FIG. 3 illustrates a method for virtual reality environment input based authentication in accordance with one or more embodiments of the present disclosure; and

FIG. 4 illustrates a method for avatar biometric indicator based authentication in accordance with one or more embodiments of the present disclosure

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with or otherwise interact with an entity. As such, in some embodiments, the user may be an individual having past relationships, current relationships, and/or potential future relationships with an entity. In some embodiments, the user may be an employee (e.g., an associate, a project manager, an IT specialist, a manager, an administrator, an internal operations analyst, or the like) of the entity or enterprises affiliated with the entity. In some embodiments, the user may be a customer (e.g., individual, business, etc.) that transacts with the entity or enterprises associated with the entity. Although described hereinafter with reference to a first user and associated first user device interacting with an example system, the present disclosure contemplates that any number of users and associated user devices may interact with the systems described herein without limitation.

As described hereinafter, the embodiments of the present disclosure control authentication in virtual reality (VR) environments, such as VR environments that are interacted with by a first user via a first user device. As such, “virtual reality” or a “virtual reality environment” may refer to any simulated experience within which a user (e.g., a first user) may be at least partially immersed (e.g., a metaverse, omniverse, etc.). For example, a virtual reality rendering may refer to a computer-generated environment within which a user may be immersed and with which a user may interact, such as via one or more VR devices (e.g., VR headset, VR mounted displayed, etc.). For example, in some embodiments, a first user device associated with the first user may be comprise one or more VR devices configured to access a VR environment. Although described hereinafter with reference a virtual reality environment, the present disclosure contemplates that the techniques described herein may be similarly applicable to an augmented reality implementation. As such, “augmented reality” may refer to any simulated or interactive experience that includes computer-generated content in conjunction with the real world environment. For example, an augmented reality rendering may refer to computer-generated visual, auditory, and/or other sensor information that is overlayed over a user's environment. The present disclosure contemplates that the system or user device(s) described hereinafter may include any component, circuitry, device, etc. configured to generate and/or access a VR/AR environment based upon the intended application of the system.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users. As described hereinafter, the systems of the present disclosure may be associated with the generation or access of virtual reality environments. As such, in some embodiments, a user interface of the present disclosure may be refer to a plurality of virtual input objects displayed within a virtual reality embodiment configured to receive a user input. The present disclosure contemplates that the arrangement, presentation, organization, etc. of the user interfaces and/or virtual input objects described herein may vary based upon the intended application of the system, the associated virtual reality environment, and/or the like.

As used herein, an “engine” or “module” may refer to core elements of an application, or part of an application that serves as a foundation for a larger piece of software and drives the functionality of the software. In some embodiments, an engine or module may be self-contained, but externally-controllable code that encapsulates powerful logic designed to perform or execute a specific type of function. In one aspect, an engine or module may be underlying source code that establishes file hierarchy, input and output methods, and how a specific part of an application interacts or communicates with other software and/or hardware. The specific components of an engine or module may vary based on the needs of the specific application as part of the larger piece of software. In some embodiments, an engine or module may be configured to retrieve resources created in other applications, which may then be ported into the engine for use during specific operational aspects of the engine. An engine or module may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” “communicably coupled” and/or the like as used herein, means that the components may be formed integrally with each other, or may be formed separately and coupled together. Furthermore, the components may be formed directly to each other, or to each other with one or more components located between the components that are operatively coupled together. Furthermore, the components may be detachable from each other, or they may permanently coupled together. Furthermore, operatively coupled components may mean that the components retain at least some freedom of movement in one or more directions or may be rotated about an axis (e.g., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, a system and an application, an accessing of stored data by one or more nodes of a computing cluster, a transmission of a requested task, or the like. As described hereinafter, an “interaction” between the system and one or more applications may be permissioned in that the ability for the system (e.g., one or more devices, subsystems, modules, etc.) to access a particular application may be controlled by permissions issued by this application. By way of a non-limiting example, a system of the present disclosure may be configured to generate a virtual reality embodiment that is accessed by a user via an associated user device. In such an example, an interaction may refer to the communication and/or transfer of data used by the user device to access the virtual reality environment.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As described above, electronic networks, communication systems, computing devices, and other systems may authenticate or otherwise verify devices and associated users that interact with these systems. For example, a user and/or associated user device may be required to provide various account credentials, passwords, biometric inputs, etc. in order to verify the identity of the user and/or user device accessing these systems. The advent of virtual reality environments that are generated, supported, or associated with these systems have provided additional complexity for authenticating device interactions. For example, a user attempting to access a virtual reality environment may be associated with a user device, one or more account credentials, and one or more avatars representing the user in the virtual environment. Traditional authentication systems, however, fail to account for these new virtual reality related attributes associated with a user and, therefore, fail to adequately secure and control these new mechanisms for authentication.

In order to solve these issues and others, embodiments of the present disclosure provide systems and methods for continual device authentication in virtual environments. An example system may receive a request for authentication of a first user device associated with a first user and the first user device may be associated with a virtual reality environment for the first user in that the first user device generates and/or accesses a virtual reality environment. The system may further receive authentication credentials associated with the first user and authenticate the first user device for accessing the virtual reality environment based on the authentication credentials. In some embodiments, the system may present various virtual input objects in the virtual reality environment to determine the authentication credentials of the user. In other embodiments, one or more biometric indicators of the first user's avatar in the virtual reality environment may be used to determine the authentication credentials of the first user. In this way, the embodiments of the present disclosure provide new methods of controlling user device authentication in virtual reality environments which were historically unavailable.

### EXAMPLE SYSTEM AND CIRCUITRY COMPONENTS

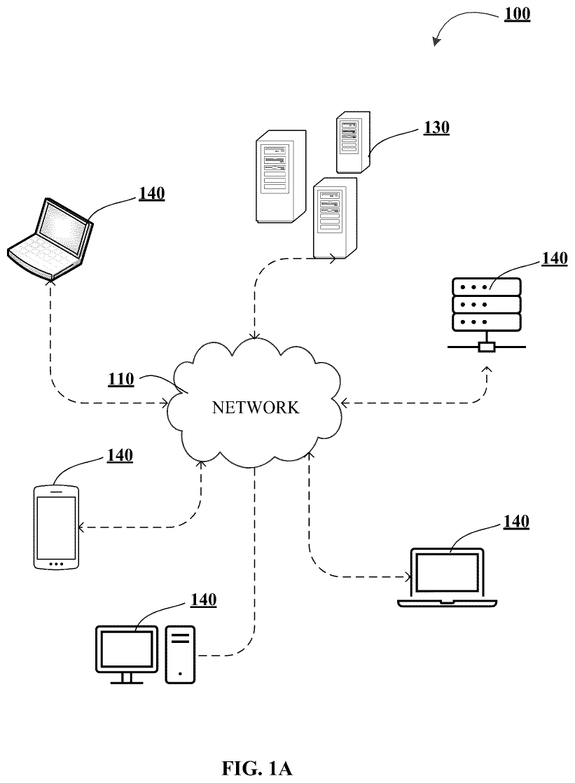

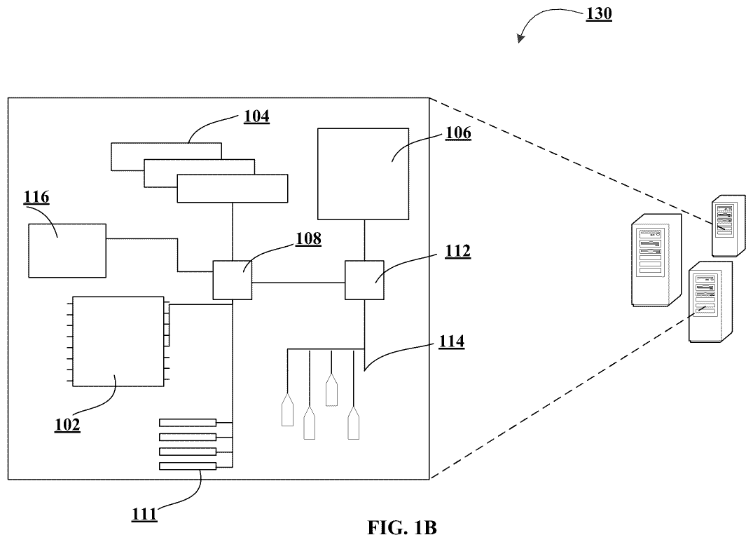

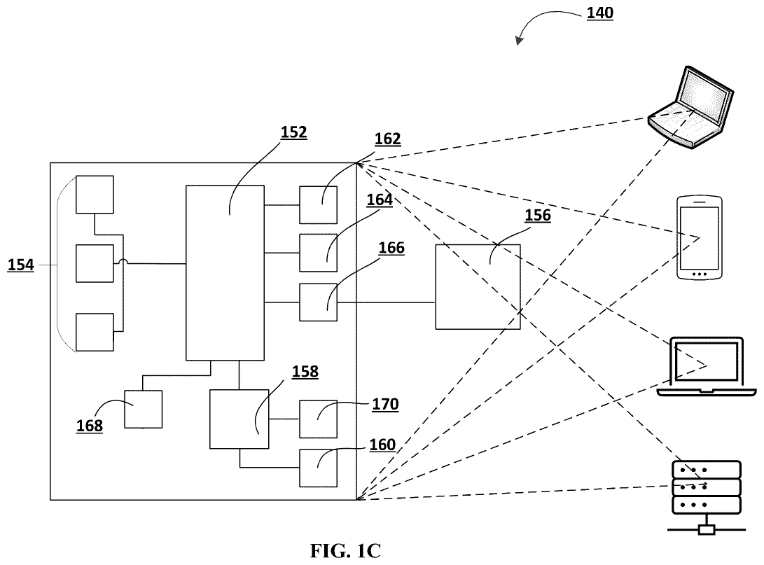

FIGS. 1A-1C illustrate technical components of an exemplary distributed computing environment for continual device authentication in virtual environments 100, in accordance with one or more embodiments of the present disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, the same or similar to system 130, with each system providing portions of the necessary operations (e.g., as a server bank, a group of blade servers, or a multi-processor system).

In some embodiments, the system 130 and the end-point device(s) 140 may define a client-server relationship in which the end-point device(s) 140 are remote devices that request and receive service from a centralized server (e.g., the system 130). In some other embodiments, the system 130 and the end-point device(s) 140 may have a peer-to-peer relationship in which the system 130 and the end-point device(s) 140 have the same abilities to use the resources available on the network 110. As opposed to relying upon a central server (e.g., system 130) that acts as the shared drive, each device that is connected to the network 110 acts as the server for the files stored thereon.

The system 130 may represent various forms of servers, such as web servers, database servers, file server, or the like, various forms of digital computing devices, such as laptops, desktops, video recorders, audio/video players, radios, workstations, virtual reality devices, augmented reality device, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, virtual reality devices, augmented reality device, and/or the like, electronic telecommunications device (e.g., an automated teller machine (ATM)), and/or edge devices such as routers, routing switches, integrated access devices (IAD), and/or the like.

The network 110 may be a distributed network that is spread over different networks. This provides a single data communication network that may be managed jointly or separately by each network. In addition to shared communication within the network, the distributed network may also support distributed processing. The network 110 may be a form of digital communication network, such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the embodiments of the present disclosure. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with one or more embodiments of the present disclosure. As shown in FIG. 1B, the system 130 may include a processor 102, memory 104, input/output (I/O) device 116, and/or a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 may process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein. In some embodiments, the processor 102 may further include circuitry components configured to generate a virtual reality environment. For example, the processor 102 may alone, or in combination with one or more of the devices or components illustrated in FIGS. 1A-1C, include hardware components configured to generate and/or render a virtual reality environment. In some embodiments, the virtual reality environment generated by the system 130 may be rendered by the system 130 for viewing by at least a first user, such as via a user device associated with the first user. As such, in such an embodiment, the system 130 may include any device, module, component, etc. configured to generate the virtual reality environment that is accessible by users via respective user devices. In other embodiments, the user devices associated with respective users (e.g., a first user device associated with a first user) may be configured to generate the virtual reality environment such that the system 130 operates to authenticate the user device without generating the virtual reality environment.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 may be capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and/or to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with one or more embodiments of the present disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a Microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user (e.g., an actionable notification or the like). The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The end-point device(s) 140 may, in some embodiments, refer to the user devices associated with respective users that may access and/or generate the virtual reality environment (e.g., a first user device associated with a first user). By way of continued example, in some embodiments, the system 130 may generate the virtual reality environment for accessing by the first user via an associated first user device. In such an example embodiment, the end-point device(s) 140 (e.g., first user device) may be configured to access a virtual reality environment generated by the system 130. To this end, the end-point device(s) 140 may include circuitry components, features, devices, etc. configured to access the virtual reality environment that is generated by the system 130. For example, the end-point device(s) 140 (e.g., first user device) may be configured to render, via a VR headset, smart glasses, etc., at least a portion of the virtual reality environment that is generated by the system 130. In other embodiments, the end-point device(s) 140 may be configured to generate and access the virtual reality environment (e.g., without generation operations performed by the system 130). In such an example embodiment, the system 130 may operate to only control authentication of the devices access the virtual reality environment but may rely upon the independent end-point device(s) 140 to generate the virtual reality environment.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, virtual reality environments, and/or any of the components described herein. To this end, the system 130 may trigger an authentication subsystem that may require the user (or process) to provide authentication credentials to determine whether the user (or process) is eligible to access the protected resources. As described hereinafter, the embodiments of the present disclosure may leverage actions performed within the virtual reality environment for authentication. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, VR/AR devices, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location- related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here may be realized in digital electronic circuitry, integrated circuitry, specially designed ASICs (application specific integrated circuits), computer hardware, firmware, software, and/or combinations thereof.

### EXAMPLE METHODS FOR CONTINUAL DEVICE AUTHENTICATION

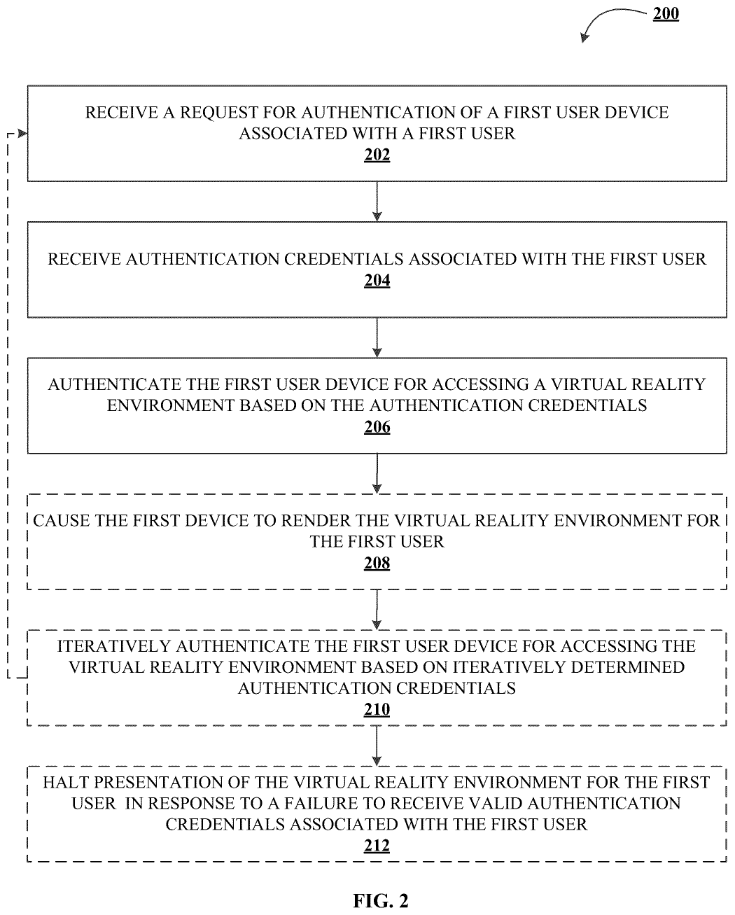

FIG. 2 illustrates a flowchart containing a series of operations for continual device authentication in virtual environments (e.g., method 200). The operations illustrated in FIG. 2 may, for example, be performed by, with the assistance of, and/or under the control of an apparatus (e.g., system 130, end-point devices 140, etc.), as described above. In this regard, performance of the operations may invoke one or more of the components described above with reference to FIGS. 1A-1C (e.g., processor 102, processor 152, etc.).

As shown in operation 202, the system 130 may be configured to receive a request for authentication of a first user device associated with a first user. As described above, the system 130 of the present application may be configured to control device authentication in virtual environments such that the first user device associated with the request for authentication is further associated with a virtual reality environment for the first user. In some embodiments, the request received at operation 202 may be received from the first user device. For example, a first user may, via a user interface presented on the first user device, provide an input requesting access to a virtual reality environment that is generated or to which access is otherwise controlled by the system 130. The request to access the virtual reality environment may be received by the system 130 at operation 202. In other embodiments, such as embodiments in which the first user device is accessing an existing session of the virtual reality environment, the request received at operation 202 may refer to the iterative authentication operations of FIG. 2 performed to continuously authenticate the interaction between the first user device and the system 130.

In some embodiments, the operations of FIG. 2 may be performed as part of an initial request to access the virtual reality environment by the first user and associated first user device. By way of an example, the first user may initially be disconnected from (i.e., or otherwise not accessing) the virtual reality environment. In such an embodiments, the operations of FIG. 2 may be performed as part of an initialization or initial authentication procedure to provide access to the virtual reality environment for the first user device (e.g., initially authenticate the first user device). In other embodiments, the operations of FIG. 2 may be performed as part of an iterative process for continuously authenticating the first user device during access to the virtual reality environment. By way of example, an authenticated session between the first user device and the system 130 may exist at the time of performance of operation 202. As such, the receipt of the request for authentication may be iteratively provided to the system 130 during a time period associated with the existing session of the virtual reality environment. In some instances, the first user device may iteratively transmit a request for authentication during access to the virtual reality environment. In other instances, the system 130 may iteratively transmit a request to the first user device for authentication credentials as described hereafter.

Thereafter, as shown in operation 204, the system 130 may receive authentication credentials associated with the first user. As described above, an interaction between the system 130 and the first user device (e.g., end-point device(s) 140) may be permissioned in that the ability for the first user device to access the virtual reality environment may be controlled by permissions issued by the system 130. In order to verify that the first user device is associated with the first user and that the first user and first user device have permission to access the virtual reality environment, one or more parameters, characteristics, attributes, etc. of the first user device and/or the first user may be required. Said differently, the first user and/or the first user device may be required to provide authentication credentials (e.g., usernames, passwords, device characteristics, biometric inputs, etc.) that identify the first user and the first user device to the system 130. The present disclosure contemplates that the authentication credentials described herein may include any feature, input, characteristic, attribute, parameter, and/or the like associated with the first user and/or first user device based upon the intended application of the system 130 and/or the nature of the virtual reality environment. By way of a non-limiting example, the authentication credentials may include one or more unique device identifiers (e.g., International Mobile Equipment Identity (IMEI), vendor number and product number (VID/PID), etc.) associated with the first user device.

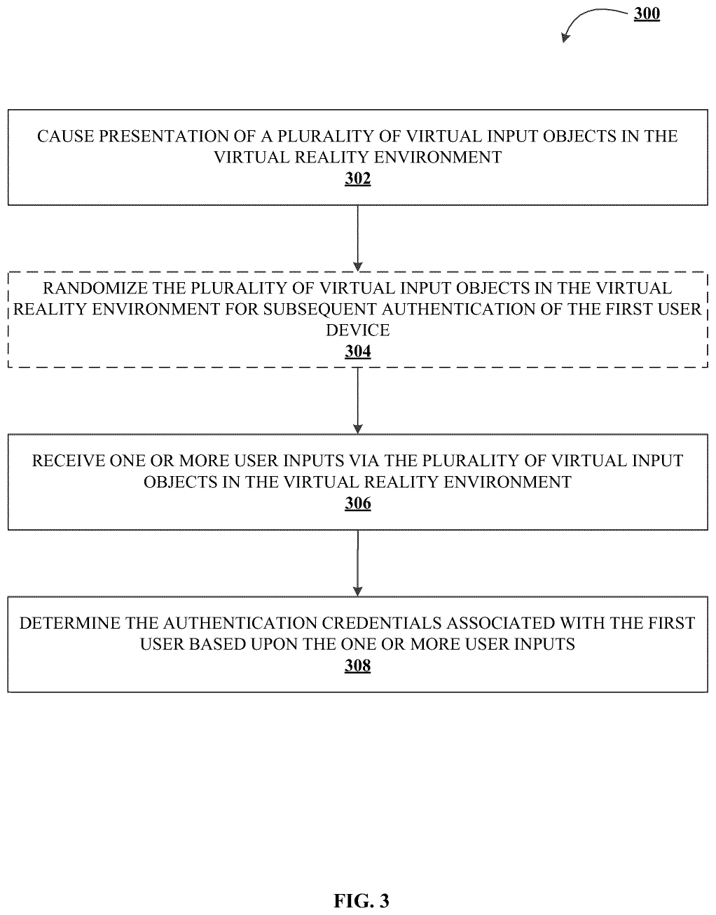

As described hereafter with reference to FIG. 3, in some embodiments, such as an instance in which the first user is currently accessing the virtual reality environment via the first user device (e.g., an existing session of the VR environment), the authentication credentials may be received in response to one or more actions by the first user in the virtual reality environment. The system 130 may, for example, cause presentation of one or more virtual input objects in the virtual reality environment through which the first user may provide the authentication credentials. By way of example, the system 130 may cause presentation of a keypad in the virtual reality environment through which the first user may provide the account credentials within the virtual reality environment. Said differently, a keypad may be virtually displayed to the first user in the virtual reality environment, and the user may input account credentials, such one or more unique device identifiers (e.g., IMEI, VID/PID, etc.) associated with the first user device. The present disclosure contemplates that the system 130 may leverage any mechanism for presenting virtual input objects to the first user within the virtual reality environment so as to receive authentication credentials of the first user within the virtual reality environment.

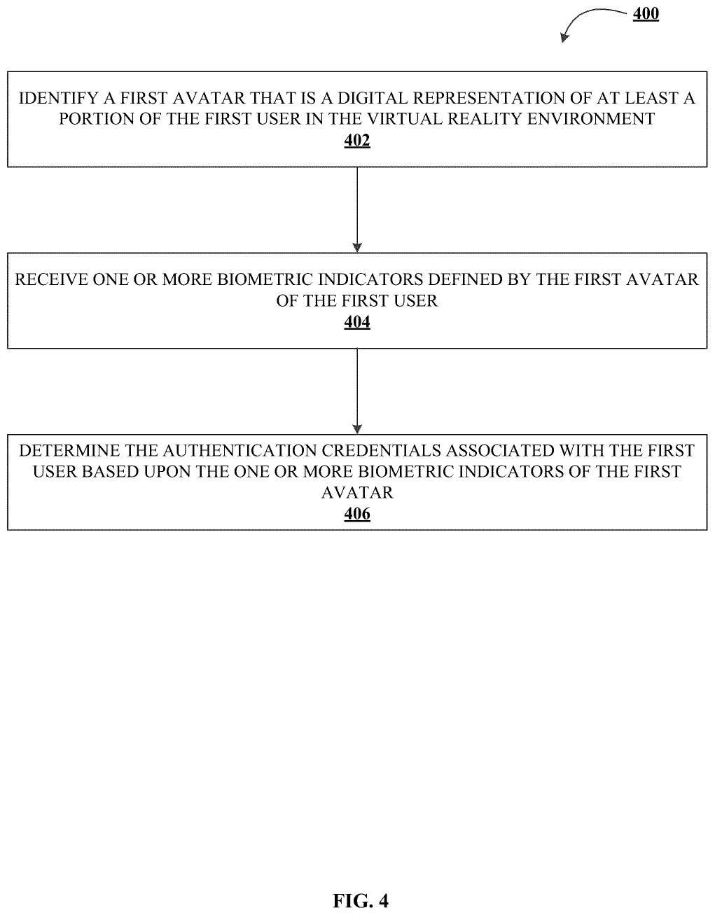

Additionally or alternatively, as described hereafter with reference to FIG. 4, in some embodiments, the authentication credentials may be received at operation 204 in response to one or more biometric indicators defined by the first avatar of the first user. As would be evident to one of ordinary skill in the art in light of the present disclosure, an avatar may refer to a digital representation of at least a portion of a user in a virtual reality environment. As such, a first avatar that is a digital representation of the first user may include various biometric indicators that are indicative of the first user digitally represented by the first avatar. By way of non-limiting example, the first avatar associated with the first user may include various features that uniquely identify the first user in the virtual reality environment. These biometric indicators, for example, may include the fingerprints, retina, and/or any other digital representation of the physical features of the first user. In such an example embodiment, the system 130 and/or end-point device(s) 140 may be configured to generate data indicative of the one or more biometric indicators of the first user and subsequently determine the authentication credentials based upon these biometric indicators. For example, the system 130 and/or end-point device(s) 140 (e.g., first user device(s)) may leverage image capture and processing techniques in order to compare biometric indicators that are defined by the first avatar and the same biometric indicators of the physical first user (e.g., facial recognition, fingerprint scanning, retina scanning, etc.) to authenticate the first user and first user device.

Thereafter, as shown in operation 206, the system 130 may be configured to authenticate the first user device for accessing the virtual reality environment based on the authentication credentials. The system 130 may be communicably coupled with one or more databases, repositories, and/or other systems that securely store verified authentication credentials associated with at least the first user. By way of example, the authentication credentials received at operation 204 may be indicative of one or more unique device identifiers provided by the first user. The system 130 may compare the provided unique device identifier with a verified device identifier associated with the first user device and authenticate the first user device in an instance in which the provided unique device identifier matches the verified device identifier. By way of an additional example, the authentication credentials received at operation 204 may be indicative of one or more biometric indicators of the first avatar. The system 130 may compare the provided biometric indicators with verified biometric indictors associated with the first user and authenticate the first user device in an instance in which the provided biometric indicators match the verified biometric indicators. Although described with reference to an example comparison between unique device identifiers and/or biometric indicators, the present disclosure contemplates that the authentication of the first user device at operation 206 may leverage any mechanism, comparison, etc. based upon the nature of the authentication credentials received.

In some embodiments, as shown in operation 208, the system 130 may further be configured to cause the first device to render the virtual reality environment for the first user. As described above, in some embodiments, the first user device (e.g., the end-point device(s) 140) include circuitry components configured to, alone or in combination with the system 130, render the virtual reality environment for viewing by the first user. As such and in response to authenticating the first user device and first user for accessing the virtual reality environment, the system 130 may transmit instructions to the first user device causing the first user device to render the virtual reality environment. As described above, the first user device may include a VR headset, smart glasses, and/or the like configured to render the virtual reality environment.

In some embodiments, as shown in operation 210, the system 130 may be further configured to iteratively authenticate the first user device for accessing the virtual reality environment based on authentication credentials iteratively determined during a time period associated with the existing session of the virtual reality environment. As described above, in some embodiments, the request for authentication received at operation 202 may be associated with an existing session of the virtual reality environment for the first user and the associated first user device. In such an example embodiment, the system 130 may operate to, at a define frequency, continuously authenticate the first user device to verify that the first user is associated with the first user. As would be evident to one of ordinary skill in the art in light of the present disclosure, a user's device (e.g., the first user device) may be lost, misplaced, or otherwise accessible by a user other than the first user. In order to maintain the security associated with the virtual reality environment, the system 130 may iteratively perform the operations of FIG. 2 to ensure that the first user is accessing the virtual reality environment via the first user device. For example, the first user may be prompted periodically to provide one or more unique device identifiers associated with the first user device, one or more biometric indicators, etc. during access to the virtual reality environment.

In some embodiments, as shown in operation 212, the system 130 may be further configured to halt presentation the existing session of the virtual reality environment for the first user and the associated first user device in response to a failure to receive valid authentication credentials associated with the first user. By way of continued example, the system 130 may periodically request authentication credentials from the first user during access to the virtual reality environment to continuously authenticate the first user device. In an instance in which the system 130 fails to receive authentication credentials and/or receives invalid authentication credentials, the system 130 may halt presentation of the virtual reality environment to the first user device. The present disclosure contemplates that the system 130 may leverage any mechanism, technique, etc. to preclude access to the virtual reality environment by the first user device.

FIG. 3 illustrates a flowchart containing a series of operations for virtual reality environment input based authentication (e.g., method 300). The operations illustrated in FIG. 3 may, for example, be performed by, with the assistance of, and/or under the control of an apparatus (e.g., system 130, end-point devices 140, etc.), as described above. In this regard, performance of the operations may invoke one or more of the components described above with reference to FIGS. 1A-1C (e.g., processor 102, processor 152, etc.).

As shown in operation 302, in some embodiments, the system 130 may be configured to cause presentation of a plurality of virtual input objects in the virtual reality environment in order to receive authentication credentials of the first user. As described above, in some embodiments, the first user may be currently accessing the virtual reality environment via the first user device (e.g., an existing session of the VR environment). In such an example embodiment, the authentication credentials may be received in response to one or more actions by the first user in the virtual reality environment. The system 130 may, for example, cause presentation of one or more virtual input objects in the virtual reality environment through which the first user may provide the authentication credentials. By way of example, the system 130 may cause presentation of a keypad in the virtual reality environment through which the first user may provide the account credentials within the virtual reality environment. Said differently, a keypad may be virtually displayed to the first user in the virtual reality environment, and the user may input account credentials, such one or more unique device identifiers (e.g., IMEI, VID/PID, etc.) associated with the first user device. The present disclosure contemplates that the system 130 may leverage any mechanism for presenting virtual input objects to the first user within the virtual reality environment so as to receive authentication credentials of the first user within the virtual reality environment.

In some embodiments, as shown in operation 304, the system 130 may be configured to randomize the plurality of virtual input objects in the virtual reality environment for subsequent authentication of the first user device during the existing session of the virtual reality environment for the first user and the associated first user device. As described above, the user device authentication operations of the present disclosure may be performed iteratively and continuously during access to the virtual reality environment. In such an embodiment, the first user may be iteratively prompted to provide user inputs via the plurality of virtual input objects in the virtual reality environment. In order to increase the security associated with this interaction, the system 130 may randomize the presentation of the user input objects to increase the complexity associated with input of the authentication credentials. By way of a non-limiting example, the order, location within the VR environment, the relative positioning between virtual input objects, the color, contrast, size, and/or orientation of virtual input objects, and/or the like may be randomized by the system 130.

Thereafter, as shown in operations 306 and 308, the system 130 may be configured to receive one or more user inputs via the plurality of virtual input objects in the virtual reality environment and determine the authentication credentials associated with the first user based upon the one or more user inputs. By way of continued example, the first user may input, via the virtual input objects, account credentials, unique device identifiers, and/or any attribute, parameter, characteristics, etc. that may be used to verify the identity of the first user and first user device. The system 130 may correlate the inputs of the first user in the virtual reality environment with the virtual input objects presented in the virtual reality environment in order to determine the authentication credential provided by the first user.

FIG. 4 illustrates a flowchart containing a series of operations for avatar biometric indicator based authentication (e.g., method 400). The operations illustrated in FIG. 4 may, for example, be performed by, with the assistance of, and/or under the control of an apparatus (e.g., system 130, end-point devices 140, etc.), as described above. In this regard, performance of the operations may invoke one or more of the components described above with reference to FIGS. 1A-1C (e.g., processor 102, processor 152, etc.).

As shown in operation 402, in some embodiments, the system 130 may be configured to identify a first avatar that is a digital representation of at least a portion of the first user in the virtual reality environment. As described above, the first user may be associated with a first avatar that includes various biometric indicators that are indicative of the first user digitally represented by the first avatar. By way of non-limiting example, the first avatar associated with the first user may include various features that uniquely identify the first user in the virtual reality environment. The system 130 may, at operation 402, identify the first avatar from amongst a plurality of avatars within the virtual reality environment that are associated with a plurality of associated users.

Thereafter, as shown in operations 404 and 406, the system 130 may be configured to receive one or more biometric indicators defined by the first avatar of the first user and determine the authentication credentials associated with the first user based upon the one or more biometric indicators of the first avatar. As described above, these biometric indicators may, for example, include the fingerprints, retina, and/or any other digital representation of the physical features of the first user. In such an example embodiment, the system 130 and/or end-point device(s) 140 may be configured to generate data indicative of the one or more biometric indicators of the first user. For example, the system 130 and/or end-point device(s) 140 (e.g., first user device(s)) may leverage image capture and processing techniques in order to generate data that is indicative of the biometric indicators of the first avatar within the virtual reality environment. The data generated by the system 130 and/or the end-point device(s) 140 (e.g., first user device) may vary based upon the nature of the biometric indicator defined by the first avatar, and the present disclosure contemplates that the first avatar may define any type of biometric indicator for user in determining authentication credentials. Furthermore, the system 130 may leverage any mechanism, techniques, etc. for analyzing the biometric indicator defined by the first avatar in order to determine the authentication credentials associated with the particular biometric indicator.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that may direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments may be configured without departing from the scope and spirit of the disclosure. Therefore, it is to be understood that, within the scope of the appended claims, the disclosure may be practiced other than as specifically described herein.

What is claimed is:

1. A system for continual device authentication in virtual environments, the system comprising:
at least one non-transitory storage device; and
at least one processor coupled to the at least one non-transitory storage device, wherein the at least one processor is configured to:
receive a request for authentication of a first user device associated with a first user, wherein the first user device is associated with a virtual reality environment for the first user;
receive authentication credentials associated with the first user; and
authenticate the first user device for accessing the virtual reality environment based on the authentication credentials.

2. The system of claim 1, wherein the processor is further configured to cause the first device to render the virtual reality environment for the first user.

3. The system of claim 1, wherein the received authentication credentials further comprise one or more unique device identifiers associated with the first user device.

4. The system of claim 1, wherein the request for authentication of the first user device is associated with an existing session of the virtual reality environment for the first user and the associated first user device.

5. The system of claim 4, wherein the at least one processor is further configured to:
cause presentation of a plurality of virtual input objects in the virtual reality environment;
receive one or more user inputs via the plurality of virtual input objects in the virtual reality environment; and
determine the authentication credentials associated with the first user based upon the one or more user inputs.

6. The system of claim 5, wherein the one or more user inputs received via the plurality of virtual input objects in the virtual reality environment correspond to one or more unique device identifiers associated with the first user device.

7. The system of claim 5, wherein the at least one processor is further configured to randomize the plurality of virtual input objects in the virtual reality environment for subsequent authentication of the first user device during the existing session of the virtual reality environment for the first user and the associated first user device.

8. The system of claim 4, wherein the at least one processor is further configured to iteratively authenticate the first user device for accessing the virtual reality environment based on authentication credentials iteratively determined during a time period associated with the existing session of the virtual reality environment.

9. The system of claim 4, wherein the first user is associated with a first avatar that is a digital representation of at least a portion of the first user in the virtual reality environment, the at least one processor further configured to:
receive one or more biometric indicators defined by the first avatar of the first user; and
determine the authentication credentials associated with the first user based upon the one or more biometric indicators of the first avatar.

10. The system of claim 4, wherein the at least one processor is further configured to halt presentation the existing session of the virtual reality environment for the first user and the associated first user device in response to a failure to receive valid authentication credentials associated with the first user.

11. A computer program product for continual device authentication in virtual environments, the computer program product comprising a non-transitory computer-readable medium comprising code that, when executed, causes an apparatus to:
receive a request for authentication of a first user device associated with a first user, wherein the first user device is associated with a virtual reality environment for the first user;
receive authentication credentials associated with the first user; and
authenticate the first user device for accessing the virtual reality environment based on the authentication credentials.

12. The computer program product of claim 11, wherein the request for authentication of the first user device is associated with an existing session of the virtual reality environment for the first user and the associated first user device.

13. The computer program product of claim 12, further comprising code that, when executed, causes the apparatus to:
cause presentation of a plurality of virtual input objects in the virtual reality environment;
receive one or more user inputs via the plurality of virtual input objects in the virtual reality environment; and
determine the authentication credentials associated with the first user based upon the one or more user inputs.

14. The computer program product of claim 13, wherein the one or more user inputs received via the plurality of virtual input objects in the virtual reality environment correspond to one or more unique device identifiers associated with the first user device.

15. The computer program product of claim 13, further comprising code that, when executed, causes the apparatus to randomize the plurality of virtual input objects in the virtual reality environment for subsequent authentication of the first user device during the existing session of the virtual reality environment for the first user and the associated first user device.

16. A method for continual device authentication in virtual environments, the method comprising:
receiving a request for authentication of a first user device associated with a first user, wherein the first user device is associated with a virtual reality environment for the first user;
receiving authentication credentials associated with the first user; and
authenticating the first user device for accessing the virtual reality environment based on the authentication credentials.

17. The method of claim 16, wherein the request for authentication of the first user device is associated with an existing session of the virtual reality environment for the first user and the associated first user device.

18. The method of claim 17, further comprising:
causing presentation of a plurality of virtual input objects in the virtual reality environment;
receiving one or more user inputs via the plurality of virtual input objects in the virtual reality environment; and
determining the authentication credentials associated with the first user based upon the one or more user inputs.

19. The method of claim 18, wherein the one or more user inputs received via the plurality of virtual input objects in the virtual reality environment correspond to one or more unique device identifiers associated with the first user device.

20. The method of claim 18, further comprising randomizing the plurality of virtual input objects in the virtual reality environment for subsequent authentication of the first user device during the existing session of the virtual reality environment for the first user and the associated first user device.
